(19) United States
(12) Patent Application Publication
(10) Pub. No.: US 2011/0251963 A1
(43) Pub. Date: Oct. 13, 2011

(54) Method for Auctioning Endorsement Agreements

(76) Inventor: Damon Rosenhan, Gilbert, AZ (US)

(21) Appl. No.: 12/757,729

(22) Filed: Apr. 9, 2010

(51) Int. Cl. G06Q 30/00; G06Q 10/00

(52) U.S. Cl. 705/80; 705/14.71

(57) ABSTRACT

A method for auctioning endorsement agreements. A network computer provides access to a plurality of users, whereby the users are capable of submitting preferences related to an endorsement or sponsorship opportunity. Other users are able to review the endorsement or sponsorship opportunities and may bid to obtain the rights. The results of the bidding process are displayed to the offeror to allow the offeror to select a favored bid, or the system may select the best bid automatically based on predefined criteria. The endorsement or sponsorship opportunity, if submitted by the prospect, may be bid upon by a sponsor/endorsee. Likewise, an opportunity, if submitted by a sponsor/endorsee may be bid upon by multiple prospects. Upon selection, a contract is generated to effect the sponsor/endorsement agreement.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to auction methods and specifically a method of auctioning endorsement deals between athletes and entertainers and companies that offer a product or a service.

2. Description of Related Art including information disclosed under 37 CFR 1.97 and 1.98

Endorsements are a common and highly effective means for advertising products and services and increasing the interest of consumers in a specific product or service. For example, nutritional supplements commonly obtain the endorsement of well known body builders, while athletic shoe companies commonly obtain the endorsement of star basketball players. The endorsement is memorialized in the form of a contract between the manufacturer of the product and the athlete. Under the typical contract, the athlete receives compensation for his endorsement and the company is allowed to use the player's name or image, or the player is obligated to appear at special events or even in commercials on behalf of the company.

A typical endorsement agreement has a term of several years to allow the company to benefit from the professional's popularity as it increases. The company is looking for a professional athlete or entertainer (hereinafter the “professional”) who would improve the good will associated with the company's product or service (hereinafter the “product”). Therefore, a professional's endorsement value goes up if he is positively perceived by the public. However, charges of domestic abuse, drunken driving or even displays of poor sportsmanship may significantly impair the professional's endorsement value. Accordingly, the company will want to be able to terminate an endorsement contract if the professional is caught up in some sort of embarrassment that could damage the goodwill associated with the product.

The professional also has a unique perspective on endorsements. In many cases, the money received from an endorsement deal is greater than the amount received by the professional for his primary activities, i.e. playing football or making movies. The endorsement contract is a mark of acceptance for the professional and can lead to other endorsements. In other words, the first endorsement can make it easier to get the second endorsement. For this reason, the professional is sometimes willing to accept less money for a first endorsement. Also, the professional may be concerned about lessening his future value if he endorses a product that is later held in low repute. Therefore, he also has a need to be able to cancel an endorsement contract under certain circumstances.

Currently professionals use a professional agent, such as IMG, to connect them with endorsement and sponsorship opportunities, and assist them in executing an agreement. This service can traditionally costs the professional twenty percent of their earnings from each of these agreements on an annual basis. In many cases, agents will spend little time on the lesser known professional, instead focusing on the bigger fees generated by stars, making it exceedingly difficult for the lesser-known professional to achieve success. In many cases these relationships create limited value for the high fees that are paid for the agent relationship. Some agents offer value added services such as travel agent assistance and personal liaison services; however many athletes view these as non value added services.

Endorsement and sponsorship activities primarily involve professional individuals and, as such, such endorsement arrangements can be prohibitively expensive for young companies to penetrate the market. Further, these young companies may be more interested in seeking acceptance of its products in a smaller or more specialized market segment. For such companies, it may make more sense for them to leverage a lesser-known professional or even an amateur in endorsing their product. However, typical agents will not handle such non-professional clients because of the lesser fees such arrangements would generate. Without a professional agent, it is difficult, if not impossible, to arrange such endorsement deals. Moreover, if a company seeking an endorsement opportunity may be able to locate an amateur athlete before he or she gains notoriety, the company may be able to enter an endorsement agreement at a more favorable sponsorship rate that spans well beyond the athlete's initial rise to stardom. If the company were to wait until stardom was achieved, such a deal may be too cost prohibitive and the company may have missed its greatest opportunity to grow in conjunction with the sponsoree's frame.

Therefore a need exists for a method of connecting companies with professionals and amateurs alike, outside of the current agent structure. Such a system should allow either party to have greater certainty in the transaction and allow for the parties to choose the terms that best suit the arrangement. The present invention satisfies these needs and others, as will be shown upon understanding of the accompanying disclosure of various embodiments thereof.

### BRIEF SUMMARY OF THE INVENTION

A method for auctioning an endorsement or sponsorship opportunity in which the steps include providing a least one networked computer processing device operable to accept a plurality of user accounts, wherein the plurality of users comprises one or more companies and one or more prospects, the first computer device capable of executing the method steps comprising: accepting a first user's endorsement or sponsorship opportunity preferences; accepting one or more bids for the first user's opportunity from one or more second users; presenting, to the first user, one or more bids meeting at least a subset of the first user's opportunity preferences; and accepting additional instruction from the first user regarding one or more presented bids. Once bidding is successful and an agreement is reached, a sponsorship or endorsement agreement is automatically generated in part from details provided during registration and bidding.

### BRIEF DESCRIPTION OF THE SEVERAL VIEWS OF THE DRAWING(S)

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a depiction of a system as described by a first embodiment of the present invention;

FIG. 2 is a screen shot of the primary interface web page of the present invention showing the arrangement of the data presented;

FIG. 3 is a screen shot of the interface in which details are shown relating to a professional musician;

FIG. 4 is a screen shot of the amateur listing of the present embodiment;

FIG. 5 is a screen shot of the interface in which details are shown relating to an amateur fighter;

FIG. 6 is a screen shot of the interface in which bidding details for an amateur athlete are disclosed; and

FIG. 7 is a flowchart depiction of the bidding algorithm in the present invention.

The above figures are provided for the purpose of illustration and description only, and are not intended to define the limits of the disclosed invention. Use of the same reference number in multiple figures is intended to designate the same or similar parts. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

As used herein, the term “sponsor” means an entity, individual, or some combination of entities and/or individuals, that finance a person's participation in a project, event, game, match, performance, or the like. The person in such an arrangement is also known as the “sponsoree.” The prospective sponsor/sponsoree arrangement is a known as a “sponsorship opportunity.” In a typical sponsorship agreement, the sponsoree receives a monetary payment for his or her participation in a project, event, game, match, performance, or the like. However, the compensation may be in any form acceptable to both parties. For example, the sponsoree may also receive, for free, products or services provided by the sponsor (e.g., a tennis professional may receive, in addition to entry and travel fees, free rackets and equipment from a sponsoring equipment manufacturer for his or her participation in a charity event).

As used herein, the term “endorser” means a person who expresses or exhibits his or her approval or support of, especially through public acts, statements, or the like, the goods or services of another person or entity. The person or entity providing the goods or services is known as the “endorsee,” and the prospective endorser/endorsee arrangement is known as an “endorsement opportunity.” In a typical endorsement arrangement the endorser receives a monetary payment from the endorsee for the endorser's acts under the endorsement agreement. However, compensation may be in any form acceptable to both parties. For example, the endorser may also receive for free the products or services that he or she endorses under the agreement.

As used herein, the term “prospect” means a professional or amateur person who is or may be considered for a potential sponsorship or endorsement arrangement.

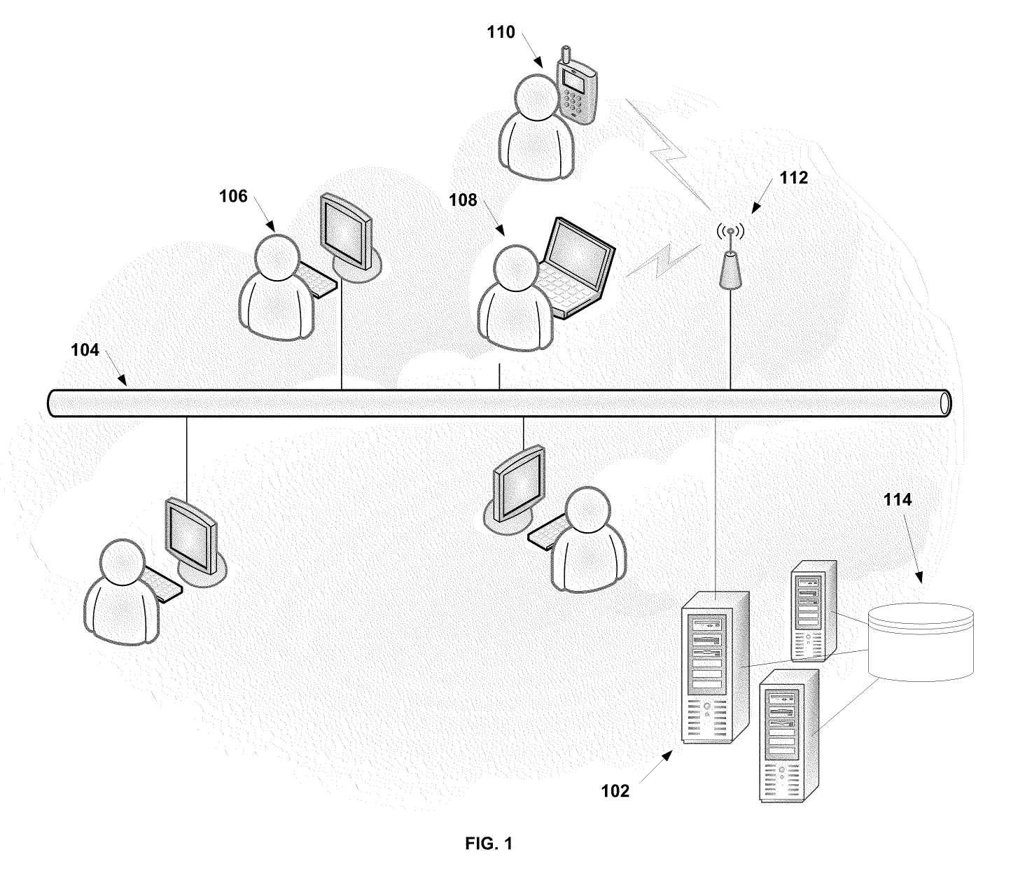

In the first embodiment, the invention is implemented as software code running on one or more computing devices accessible over an Internet network connection. FIG. 1 depicts such a system. As shown, one or more computer processing devices (102) communicate with a plurality of users (106) over a physical network connection (104), or a wireless connection (112). Users may, therefore, access the system using a desktop computer (106), laptop, notebook, or notepad computer (108) that is wired (104) or wireless (112), or a smart phone (110) or other similar device capable of generating a user interface for exchange of data with the processing device (102). One or more database devices (114) support the system by providing a robust repository for user data.

Users of the present embodiment include professional and amateur persons seeking sponsorship or endorsement opportunities (sponsorees/endorsers), as well as entities or individuals seeking same (sponsors/endorsees). Sponsorees/endorsers include artists, actors, athletes, musicians, and the like, essentially anyone who may participate in a sponsorship or endorsement opportunity. Further, users of the system may also be fans that are merely interested the sponsorship and endorsement arrangements of his or her favorite persons. The service is also popular among marketers and others whose business can benefit from such knowledge.

The networked computer processing devices (102) are capable of executing computer program instructions to perform the novel processing steps of the invention. This device can be a general purpose computer that becomes special purpose upon execution of the program steps, such as a web server or similar database device, or a special purpose processing device such as an embedded controller, microcontroller, digital signal processor (DSP), or programmable hardware logic device such as an ASIC, ASIP, CPLD, FPAA, FPGA, or the like.

Depending on the hardware utilized, the novel method steps may be implemented in software form, hardware logic, or some combination of software and hardware. Further, more than one processing device (102) may be utilized and configured such that the processing tasks of the embodiment are distributed across the devices (102). Such distribution may afford increased speed or efficiency in operation. The implementation of the software in the embodiment can be in any programming language, such as C, C++, C#, .NET or the like and is considered to be within the capabilities of one of ordinary skill in computer programming and web development.

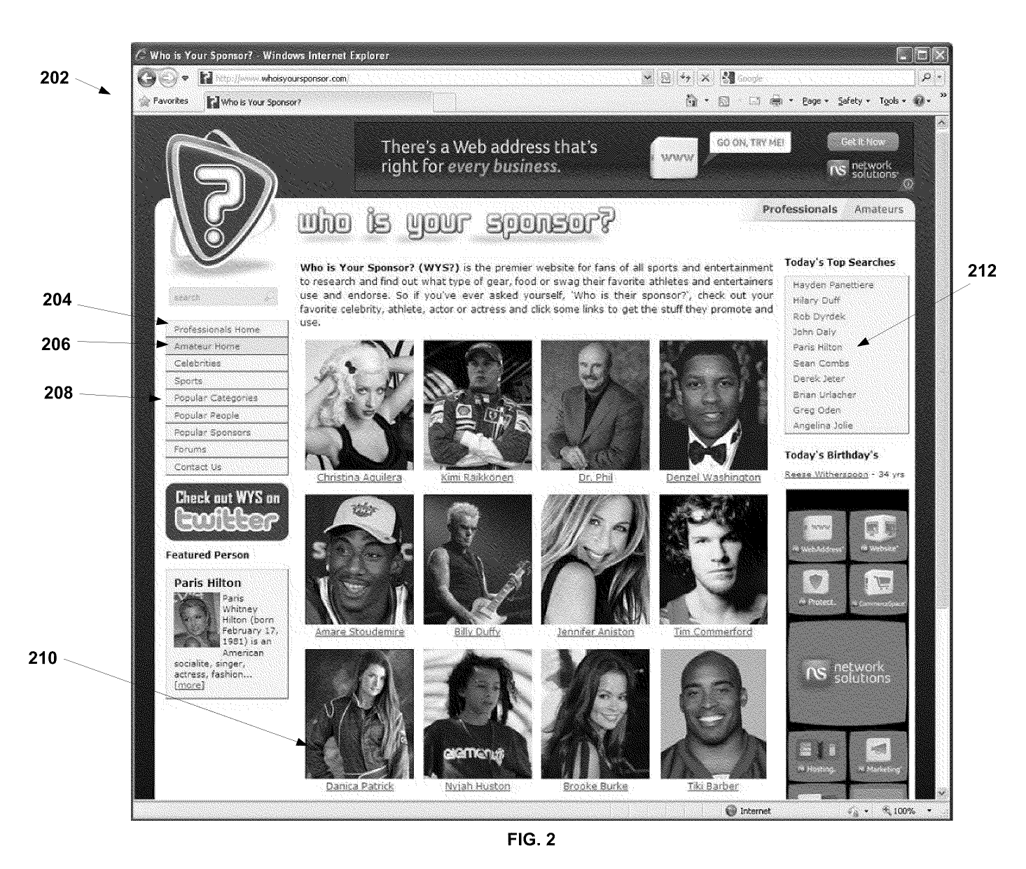

FIG. 2 depicts a screenshot of the primary Internet page (202) of the current embodiment. As depicted, the interface is generated in a user's web browser when the user directs his or her browser to the appropriate web page URL. Served to the user's browser in HTML format, the page is rendered with appropriate images and hyperlinks to additional data. On the left of the primary page (202) are a group of links to more detailed information as well as a page for registering as a user (person or entity), while the center of the page presents images of professional persons with hyperlinks to additional detailed information concerning the respective person. For example, sponsorship and endorsement information concerning Danica Patrick (210), a NASCAR driver, can be obtained by selecting the appropriate hyperlink beneath her image. On the right of the depicted primary page (202) is a group of hyperlinks representing the most popular professionals based upon searches with the embodiment.

The current embodiment provides a novel means for auctioning and bidding on sponsorship or endorsement opportunities involving both professional persons and amateur persons alike. The left group of links allows the user to browse to the list of professionals (204) or browse to the list of amateurs (206), or to categories sorted by type and popularity (208). Links to the amateur listing (206) and persons sorted by categories (208) are also provided.

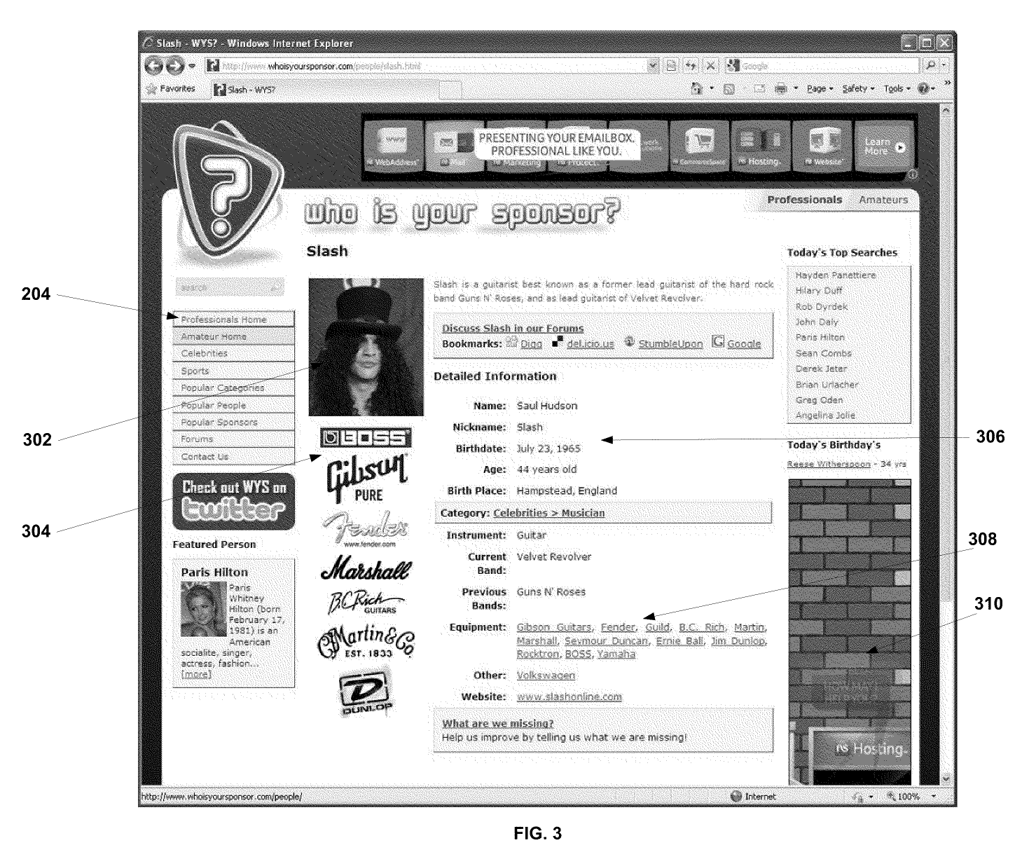

Upon selecting one of the professionals links, the user is presented with a page providing a greater amount of detail regarding the professional. For example, FIG. 3 depicts the details concerning sponsorships and endorsements for the rock guitar player Slash (302). On the left of this page is an image of Slash (302) and the product markings of the goods or services that he endorses (304). As shown, Slash endorsed Gibson guitars, Fender guitars, Marshall amplifiers, BC Rich guitars, Martin & Co. guitars, and Dunlop strings. Links to each of these sponsor or endorsee pages are provided (308) in addition to greater personal detail (306) concerning the professional. The present embodiment also provides space on each page for display of targeted advertisements (310) to increase revenue for the utility.

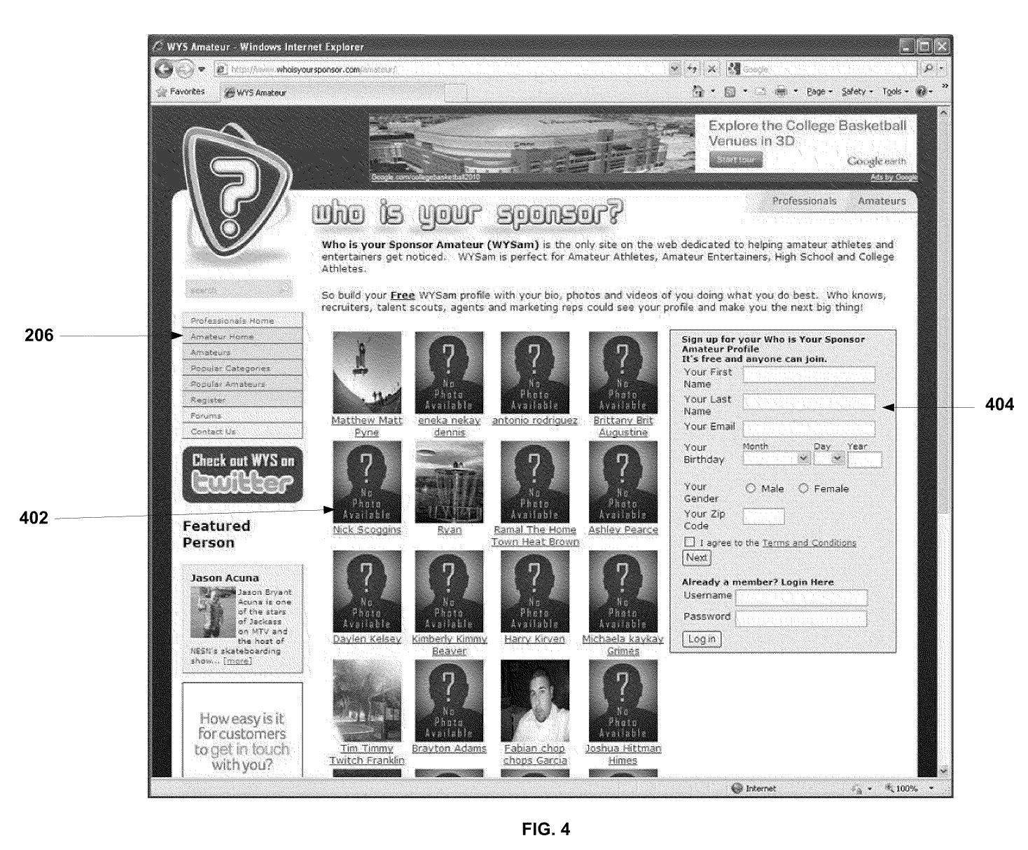

Turning once more to the primary page of FIG. 2, the user has the opportunity to view amateur persons registered with the system (206). Selecting this link leads the user to a page upon which a listing of registered amateurs is displayed such as that depicted in FIG. 4. As shown, images and respective links to registered amateurs appear near the center of the page (402). On the right of the display is a section for a person having a current registration with the system to log-in to update or review his or her personal data and account activity, or for a new person to register with the service (404). Upon registration, the person is able to enter, review, and edit his or her personal information as well as initiate, bid, contract, and track endorsement and sponsorship relationships of which the person is a party.

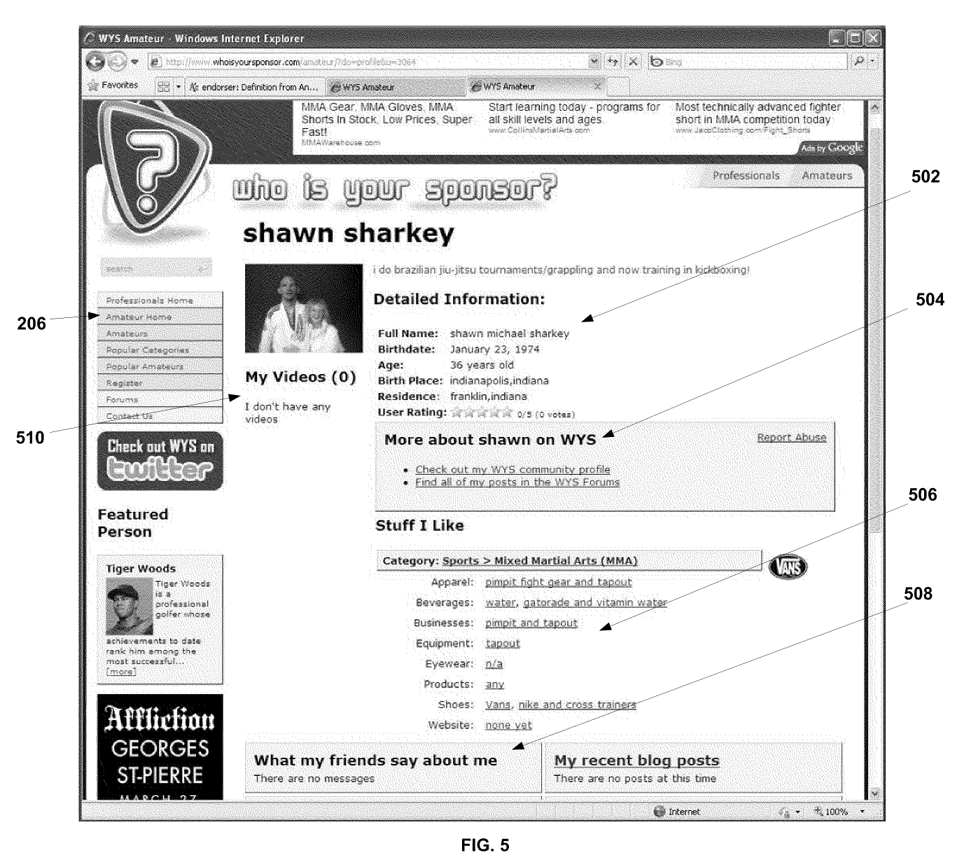

As with the professional detail page, selecting an amateur's image or related hyperlink will provide a page having additional detail concerning the amateur. FIG. 5 depicts the amateur detail page of the present embodiment. As depicted, the amateur user has provided an image and details such as name, birth date, age and hometown (502). The amateur has also entered details concerning the types of products and services he or she frequently uses (506). The provision of such information is intended to alert the entities or individuals that manufacture and sell these goods and services in order to entice the entity or individual to consider a sponsorship or endorsement opportunity with the amateur. The page also features space for reviews and recommendations by others as to the amateur's popularity or prowess, as well as space for blog posts or retransmitted posts from other social networking sites (508). Such reviews and recommendations are intended to improve the amateur's chances of receiving a sponsorship or endorsement deal. The amateur is also able to upload and provide video (510) of his or her abilities to assist in this selection.

Although most professionals rely on professional agents to handle their endorsement and sponsorship deals, it is also possible for a professional to utilize the present invention, in the same manner as an amateur, to forgo use of such agents and payment of the requisite fees.

The present invention essentially eliminates the need for agents to broker endorsement deals by introducing companies to professionals/amateurs through an automated auction process. By eliminating the broker, both parties are able to appropriately price the value of the endorsement. For the prospect, he or she is able to bid at a level he or she is willing to accept. Likewise, for the company, the cost of the endorsement can be capped. In the event that the cap is lower than a particular professional will accept, then the company will still be presented with a number of professionals who will accept that capped amount. In any case, more value is realized by both parties by eliminating the cost of the broker.

A company seeking an endorser, or sponsoree, is provided an opportunity to auction off their endorsement agreements to the highest bidder, thus maximizing their value, while paying a one-time transaction fee. This also applies to amateurs seeking an initial sponsorship or endorsement agreements as well as professionals. The embodiment provides a brief profile of the professional, their current endorsement relationships if applicable, the current amount and expiration date of these agreements. In accordance to their agreement, the sponsoree would have the opportunity to initiate the bidding process prior to the expiration of their current agreement to allow adequate time for the auction and contracting processes. An additional fee could also be charged to help structure the agreement as part of the one-time fee.

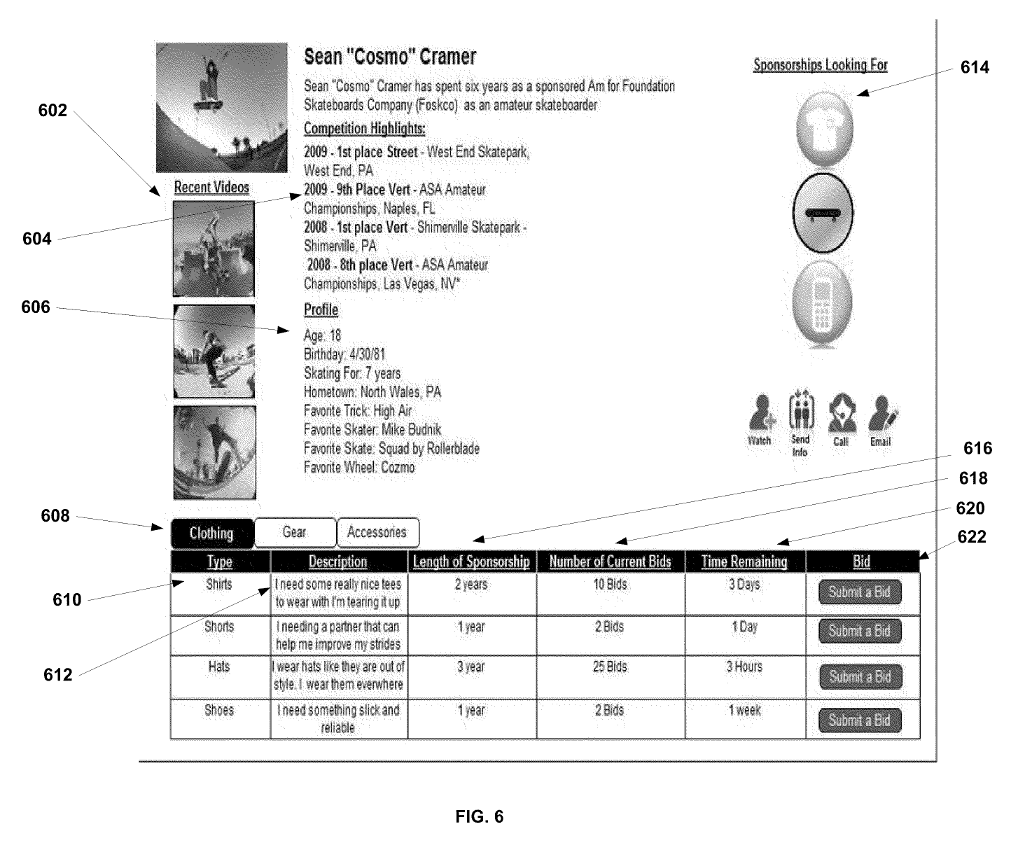

FIG. 6 depicts a typical prospect's detail page provided to an entity or individual reviewing the prospect for a potential sponsorship or endorsement opportunity. To assist in the determination, the prospect can provide images and videos of his or her abilities (602). A brief bio for the prospect is also provided, and includes information such as amateur or professional experience (604) as well as the prospects personal profile (606), including information such as age, birthday, home town, level of experience, favorite activities, favorite goods/services related to the activities, etc. Icons are also provided that reflect the types of sponsorship/endorsements the prospect is interested in (614) including links to means for contacting the prospect. On the bottom of the page is a spreadsheet-style arrangement presenting additional details concerning the types of sponsorship/endorsement opportunities sought (608) such as clothing, gear, accessories, etc. As shown, the prospect enters information such as the type of goods (610), a brief description of the necessity for the goods (612), and the length of sponsorship/endorsement sought (616). A button is provided to allow the entity or individual reviewing the prospect to enter a bid for a desired opportunity (622). The system then tracks the number of current bids (618) and time remaining in the bid cycle (620).

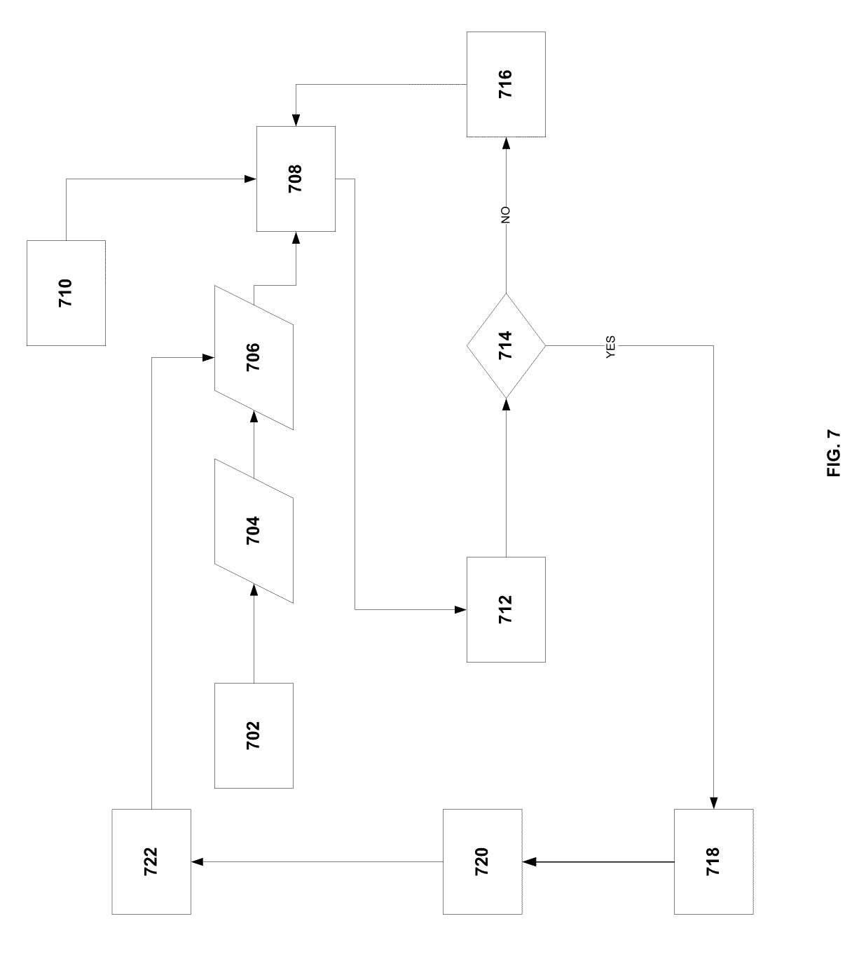

FIG. 7 presents a flow diagram of the steps taken by an embodiment in conducting a bid cycle. To begin, a prospect (athlete, artist, model, etc.) registers with the system (702). Upon registration, he or she builds a profile by entering critical data such as, but not limited to, name, age, height, weight, and the like, and submits images and/or videos (704). Once the base profile is constructed, the prospect enters details related to the sponsorship or endorsement opportunities sought (706). These details include, but are not limited to, minimum amount the prospect is willing to accept for a sponsorship or endorsement opportunity, length of the contract sought, exclusivity of the arrangement, acceptable brands and product types, and the like.

Entities or individuals seeking to sponsor someone or to have someone endorse its goods or services must also register with the system (710). This entity or individual enters and builds a profile much the same as the prospect, providing sufficient information to allow the prospect to evaluate the favorability of a sponsorship or endorsement arrangement with the entity or individual.

Once the prospect has finished constructing his or her profile and desired opportunities, the bidding is initiated (708). The bidding cycle then runs for a period of time that is either fixed by convention, or specified by the prospect. The prospect then receives and reviews bids placed by the potential sponsor/endorsee (712) and a decision is made as to whether or not to enter into the arrangement (714). If the decision is no, the prospect has the ability to adjust his or her profile and opportunity requirements (716) and to reinitiate the bidding process (708). However, if the bid is selected and accepted (718), the prospect enters into a contract with the sponsor/endorsee (720) and the contract duration begins (722). Upon expiration of the contract the sponsoree/endorser may reassess his or her position and update his or her profile and bidding details prior to beginning the cycle once more.

The steps are similar for the situation in which a sponsor/endorsee seeks bids from prospects for a sponsorship or endorsement opportunity. Again, upon registration with the system (702) the sponsor/endorsee builds a profile of information to present to bidders (704). The sponsor/endorsee then enters details concerning the proposed sponsorship or endorsement opportunity that are sufficient to allow the bidders to determine the favorability of such an arrangement (706). This detail may include a maximum amount that the sponsor/endorsee is willing to pay to establish a sponsorship or endorsement agreement. The prospective sponsorees/endorsers register with the system (710) and the bidding is initiated (708). The sponsor/endorsee receives any bids that were placed (712) and determines, based upon the bid criteria, the favorability of the prospective relationship (714). If the sponsor/endorsee rejects the bids, it may adjust its profile and bidding requirements (716) and reinitiate the bidding process (708). However, if a bid is selected and accepted (718) the sponsor/endorsee and sponsoree/endorser enter into a contract (720) and the contract duration begins (722). Upon expiration of the contract the sponsor/endorsee may reassess its position and update its profile and bidding requirements prior to beginning the cycle once more.

With the present embodiment, the sponsorship or endorsement agreement is automatically drafted in part using details provided by the parties on registration and during the bidding process. In this manner, it is relatively easy for the parties to modify the resulting agreement by modifying these requirements before and during the bidding process. Other contract details are provided during subsequent negotiation or are provided from the outset as default contract provisions. The present embodiment also utilizes another individual (third-party) to handle and draft the contract terms. Yet another embodiment utilizes a fully automated system that automatically generates the contract terms.

In a typical bidding cycle, each bidder with privilege to participate may submit only one bid per sponsorship or endorsement opportunity. However, in another embodiment it is possible for the bidder to enter multiple bids for a single opportunity. This allows the bidder to “bracket” the opportunity to increase its chances of success. For example, an athlete may be bidding on an endorsement opportunity for running shoes. In his first bid the athlete indicates that he will endorse the shoes for $100,000 per quarter. In a second bid, the same athlete may indicate that he is willing to accept $50,000 per quarter in addition to a quantity of the running shoes and an advance option on endorsement of the next version of the shoe. This allows the athlete to effectively put forth the alternatives he is willing to accept and may improve his chances of closing the deal. The same goes for the situation in which a sponsor/endorsee is bidding on an opportunity with a prospect. For example, the shoe manufacturer may locate an athlete it wants to endorse its shoes. The manufacturer may submit a first bid that features an offer of payment of $100,000 per quarter for the endorsement, and a second bid that features an offer of payment of $50,000 and a quantity of shoes.

Although the present embodiment describes use of a web server and users accessing the service over Internet connections, it is also possible for the system to be restricted to a dedicated network divorced from the Internet. For example, the network may be limited to a local area network that only authorizes access via dedicated lines, such as phone lines or wireless connections. Other versions of networks are equivalent and are within the scope of the present invention.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g. read only memory devices within a computer such as ROMs or CD-ROM disks readable only by a computer I/O attachment); (b) information alterably stored on writeable storage media (e.g. floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

I claim:

1. A method for auctioning an endorsement or sponsorship opportunity, the method steps comprising:
providing a least one networked computer processing device operable to accept a plurality of user accounts, the first computer device capable of executing the method steps comprising:
accepting a first user's preferences for an endorsement or sponsorship opportunity;
accepting one or more bids for the first user's opportunity from one or more second users;
presenting, to the first user, one or more bids meeting at least a subset of the first user's opportunity preferences; and
accepting additional instruction from the first user regarding one or more presented bids.

2. The method of claim 1, the method steps further comprising:
automatically matching, via the computer processing device, the first accepted bid that meets each of the first user's opportunity preferences.

3. The method of claim 1 wherein each second user may submit only one bid.

4. The method of claim 1 wherein each second user may submit multiple bids for a given opportunity.

5. The method of claim 1, the method steps further comprising:
ranking the bids that meet at least a subset of the first user's opportunity preferences, wherein the rank is based upon the opportunity preferences.

6. The method of claim 1, the method steps further comprising:
accepting a winning bid instruction from the first user regarding the bid that the first user wishes to accept; and
automatically generating at least a portion of a contract for the endorsement or sponsorship opportunity based upon the winning bid instruction, one or more of the opportunity preferences and one or more of the bid details.

7. The method of claim 1 wherein the additional instruction includes changing one or more of the opportunity preferences and reinitiating the bid acceptance process.

8. The method of claim 1 wherein the first user is a company and the second users are prospects, and wherein the endorsement or sponsorship opportunity preferences are for an endorsement opportunity comprising:
a product or service description; and
a maximum monetary amount the first user is willing to pay to a successfully bidding second user to endorse the product or service.

9. The method of claim 1 wherein the first user is a company and the second users are prospects, and wherein the endorsement or sponsorship opportunity preferences are for a sponsorship opportunity comprising:
an event description; and
a maximum monetary amount the first user is willing to pay to a successfully bidding second user to attend the event.

10. The method of claim 1 wherein the first user is a prospect and the second users are companies, and wherein the endorsement or sponsorship opportunity preferences are for an endorsement opportunity comprising:
a product or service description; and
a minimum monetary amount the first user is willing to accept from a successfully bidding second user to endorse the product or service.

11. The method of claim 1 wherein the first user is a prospect and the second users are companies, and wherein the endorsement or sponsorship opportunity preferences are for a sponsorship opportunity comprising:
an event description; and
a minimum monetary amount the first user is willing to accept from a successfully bidding second user to attend the event.
